(19) United States
(12) Patent Application Publication
(10) Pub. No.: US 2022/0106747 A1
(43) Pub. Date: Apr. 7, 2022

(54) METHOD AND APPARATUS FOR SAND DUNE CONSTRUCTION

(71) Applicant: Emmet Ferguson, Jacksonville, FL (US)

(72) Inventor: Emmet Ferguson, Jacksonville, FL (US)

(21) Appl. No.: 17/489,006

(22) Filed: Sep. 29, 2021

Related U.S. Application Data
(60) Provisional application No. 63/088,104, filed on Oct. 6, 2020.

(51) Int. Cl. E01F 7/02; E04H 17/16; E02B 3/04

(52) U.S. Cl. CPC E01F 7/025; E02B 3/04; E04H 17/166

(57) ABSTRACT

A movable apparatus for sand dune construction. A fence having a lateral stability bar, a plurality of vertical stability bars, and a plurality of cross-hatched sand wall planks may be positioned at a location at which sand dune construction is desirable. In some embodiments, multiple apparatus may be connected together to allow for adjustment of the alignment of the apparatus. Additionally, in some embodiments, the angles of the sand wall planks may be adjusted. Together, these additions may help customize a sand passthrough profile.

### FIELD OF THE INVENTION

The present invention relates to a method and apparatus for passive sand dune construction.

### BACKGROUND OF THE INVENTION

Sand dunes are critical to the ecological and physical safety of many seaside environments. Sand dunes allow flora and fauna to grow with some protection. Sand dunes provide privacy to beach homeowners. And sand dunes help mitigate damage from catastrophic coastal storms, like hurricanes.

In particular, many types of wildlife, including animals and vegetation, depend upon well-developed sand dunes in order to survive. For example, turtles incubate their eggs in sand dunes. It is obvious to most that a well-developed sand dune is required for sea turtle procreation. In addition, recently it has been discovered that the presence of microplastic microfibers in sand making up sand dunes can affect the temperature of the sand and therefore in turn affect the habitat of animals such as sea turtles. Plastic has a higher specific heat than natural sand particles. Since the incubation temperature of sea turtles is instrumental in determining a sex ratio of sea turtle hatchlings, it is important to have homogenous sand that has a low concentration of plastic microfibers.

Sand dunes form naturally when wet sand is deposited along the coast and dries out. Dunes traditionally form where the beach is wide enough to allow for the accumulation of wind-blown sand. While dunes erode over time, they are also replenished over time.

Sand dunes can also be created artificially. There are two prevailing methods to do so. The first is to plant certain fauna that tend to make blown sand stay in place. The second is to build a fence that lets sand into a predefined area but does not let it out.

The fences known in the art tend to be permanently placed, slatted fences. These may be deployed in a variety of patterns, such as sawtooth waves. However, they are semi-permanent, create unappealing eyesores for beach goers and interfere with animal life.

### SUMMARY OF THE INVENTION

Accordingly, the present invention provides a methods and apparatus for creation of sand dunes in specific designated areas with portions of sand with relatively higher homogeneity of natural sand particle.

A first step in constructing the sand dune is to determine and designate one or more areas on which a dune is to be constructed. This determination may be based upon the presence or absence of an active or inactive turtle population, desired flora content, or the needs of other wildlife in the area. Designate one or more areas on which dune is to be constructed.

Once a desirable location is determined, wind direction in that area should be monitored for general trends or specific time periods. This may be determined by, for example, placing a weathervane blade on top of a fence post in an area proximate to the location in which a dune is to be constructed. An anemometer may also be deployed where a wind intensity is desired to be obtained.

In some embodiments, based upon the wind direction, a fence panel may be arranged at a desired angle relative to the wind direction. In some embodiments, this angle may be perpendicular or 0-89.99 degrees. A pattern of panels may then be arranged. This pattern may include a single layer or multiple layers. Where multiple layers are used, these may be at the same or different angles to wind depending upon a desired shape of a dune. By using multiple layers, specific areas of diminished air speed may result, thus creating specifically tailorable patterns of sand.

The size of openings in the fence may also be tailored to wind speed or to the distance sand particles should travel after passing through the fence. In addition, multiple layers of fence panels may have different sized openings to trap sand particles between the panels. Moreover, depending upon the location, the nearby sand may have larger or smaller sized or weighted particles. Accordingly, the relative weight of sand particles may be considered in choosing the placement of fence panels in relation to the area in which to create sand dunes. In some embodiments, the dunes may be supplemented by plastic fiber or artificial sand particles, which may have a different weight and effect on local flora and fauna than natural sand.

After creating one sand dune, more sand dunes may be created in an area. This may be used, for example, to provide protection for turtles against natural predators. For instance, patterns of sand dunes may be used to protect cover from crows and seagulls (compared to the amount of cover that would be available on a beach). Similarly, sophisticatedly placed sand dunes could nurture various flora that could also provide cover from crows or seagulls.

In some embodiments, fences erected in accordance with the present invention may remain proximate to the created sand dune for short, medium, or long terms of engagement. In such embodiments, it may be desirable to suspend fence posts off of ground to allow turtles to pass underneath. A color-coded flag may be placed on a fence post to indicate the relative height of the lowest panel. (For example, a red flag may indicate a relatively low opening between the fence and the sand, while a green flag may indicate a relatively high opening.). This may also be necessary to ensure compliance with local rules during, for example, turtle mating seasons.

A fence post may be configured to support several panel heights for the fence. Moreover, these fences may be stacked to adjust for wind speed or a rate at which a sand dune should be built. For example, a higher fence will capture more sand particles. The fence may be stacked to adjust an amount of protection provided by fence panels from sea wind, which contain salt and sand.

Fence panel slats may be of a material suitable to capture freshwater moisture in the air. They may also collect fresh water to nature plants located proximately to the fence. In some embodiments, the panels may be curved to achieve this purpose.

The construction of the sand dunes may be accomplished via deployment of mobile fence portions that may easily be carried an installed by an able bodied person without the need of special machinery. The mobile fence portions may include a plurality of cross-hatched planks. According to the present disclosure, a set of cross-hatched sand wall planks are attached to a lateral stability bar and a plurality of vertical stability bars. The vertical stability bars may be planted into the ground to create a temporary sand wall apparatus. This allows for ad hoc creation of sand dunes.

In some embodiments, a plurality of these sand wall apparatus may be movably connected to generate a sand passthrough profile. Additionally, in some embodiments, the angles on the cross-hatching pattern of the sand wall planks may be movably adapted. Together, these improvements allow a user to determine a location for a sand dune and adjust the apparatus based on local environmental conditions, such as a volume of sand or a wind velocity.

### DESCRIPTION OF THE DRAWINGS

The accompanying drawings, which are incorporated in and constitute a part of this specification, illustrate several embodiments of the disclosure. Together with the description, these drawings serve to explain the principles of the disclosure:

FIG. 1 illustrates an exemplary embodiment of the apparatus for passive sand dune construction.

FIGS. 2A-2C illustrates an exemplary embodiment of a connected version of a plurality of apparatus for passive sand dune construction.

FIG. 3 illustrates an alternative embodiment of the apparatus for passive sand dune construction.

FIG. 4 illustrates an alternative embodiment of the apparatus for passive sand dune construction that uses curved panels.

FIGS. 5A-5B illustrate an alternative embodiment of the apparatus for passive sand dune construction in which two or more such apparatus are positioned at varying heights.

FIG. 6 illustrates an alternative embodiment of the apparatus for passive sand dune construction in which two such apparatus are positioned at an acute angle relative to each other.

FIG. 7 illustrates a flowchart for an exemplary method of constructing a sand dune, in accordance with the present invention.

### DETAILED DESCRIPTION

The present invention relates to methods and apparatus for using a sand dune apparatus to construct a sand dune. The sand dune apparatus is a generally portable, cross-hatched fence, having a top, lateral stability bar to hold the cross-hatched planks and a pair of vertical stability bars for securing the fence into the ground.

In the following sections, detailed descriptions of examples and methods of the invention will be given. The description of both preferred and alternative examples, though thorough, are exemplary only. It is understood that, to those skilled in the art, various, modifications, and alterations may be apparent. The examples do not limit the broadness of the aspects of the underlying invention as defined by the claims.

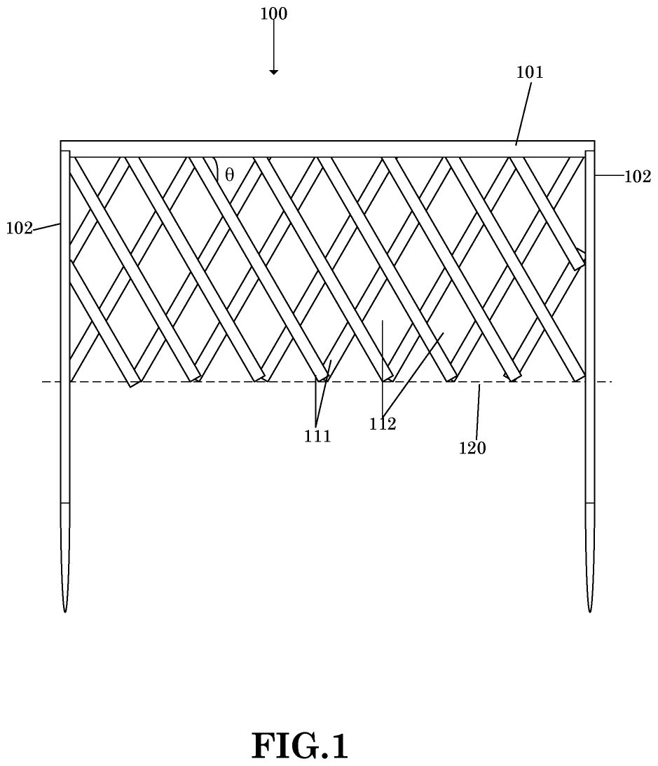

FIG. 1 illustrates an exemplary embodiment of the apparatus for passive sand dune construction. Sand dune apparatus 100 may comprise lateral stability bar 101, vertical stability bars 102, and a plurality of sand wall planks 111. In exemplary embodiments, lateral stability bar 101 extends across the length of at least a subset of the plurality of sand wall planks 111. A subset of the sand wall planks 111 may be attached to lateral stability bar 101 (such as, for example, by nails), and extend diagonally away from lateral stability bar 101 at angle θ (which may be the same across all sand wall planks 111 or vary depending upon location). In exemplary embodiments, the sand wall planks 111 may extend coplanarly in opposite directions from lateral stability bar 100, such that the sand wall planks 111 form a cross-hatch pattern. Other patterns may be desirable as well. Some of the sand wall planks 111 may extend diagonally away from lateral stability bar 101 and extend through to a ground plane 120.

Other sand wall planks 111 may extend diagonally from lateral stability bar 101 and extend through to vertical stability bar 102. These sand wall planks 111 may be attached to vertical stability bar 102, be removably attached to vertical stability bar 102, or simply rest at a location proximate to vertical stability bar 102.

Additional sand wall planks 111 may originate from other sand wall planks 111, rather than to lateral stability bar 101. These may also terminate at ground plane 120 or at vertical stability bar 102 (or a location proximate thereto). A first sand wall plank 111 may be fixably, movably, or removably attached to a second sand wall plank 111 to allow for additional stability.

Vertical stability bars 102 may be fixedly or removably attached to either end of lateral stability bar 101. Vertical stability bars 102 may extend to ground plane 120 or beyond ground plane 120, to allow the sand dune apparatus 100 to be mounted in sand. In some embodiments, the distal end of the vertical stability bar 102 (i.e., the end away from the lateral stability bar 101) may take various shapes that may be useful in helping mount sand dune apparatus 100. For example, the distal end of vertical stability bar 102 may be substantially shaped like a spike or a peg to allow the end to penetrate the ground. In some embodiments, one or more secondary stability bars may be attached to vertical stability bars 102 (or on lateral stability bar 101 or on one or more sand wall planks 111) extending downward at an angle (and in a direction substantially perpendicular to the lateral stability bar 101) to bolster the stability of sand dune apparatus 100 once it is mounted. In some embodiments, the stability of sand dune apparatus 100 may be further secured by burying an anchoring structure proximate to the desired location of sand dune apparatus 100 (such as a piece of plywood), extending secondary stability bars to the anchoring structure, and securing the secondary stability bars into the anchoring structure by means of, e.g., bolts or screws.

In exemplary embodiments, each of the lateral stability bar 101, vertical stability bars 102, and sand wall planks 111 may be comprised of materials appropriate for outdoor, humid conditions. For example, the material may be wood (including a water-treated wood), plastic, PVC, or other similar outdoor-resistant material. The material may be organic to prevent accidental harm to wildlife. In some embodiments, the material may be semi-permeable to allow some quantities of sand to get through the sand dune apparatus 100 without endangering the structural integrity of sand dune apparatus 100. The material may be flexible to allow for dynamic adjustment of a sand passthrough profile based upon wind or other environmental factors. For example, sand wall planks may be made of a stiff but flexible material, such as the vinyl or PVC draft curtains used to regulate airport luggage dispensing.

The cross-hatching of sand wall planks 111 creates a plurality of sand wall holes 112. The size of sand wall holes 112 may be adjusted by varying θ. It may be desirable to adjust the size of sand wall holes 112 based on one or more of: weather conditions, granularity of sand, volume of sand to be collected, sturdiness of mount achieved by vertical stability bars 102, wind conditions, aesthetic considerations (such as a desirability of a view of an ocean), or other similar factors.

While some embodiments of sand dune apparatus 100 may come prefabricated, other embodiments may allow for ad hoc adjustment of angle 0. For example, in one embodiment, one or more sand wall planks 111 may be joined to lateral stability bar 101 by means of a sliding mount. In some embodiments, some of these sand wall planks 111 may also be joined to other sand wall planks 111 by another sliding mount for additional flexibility. As another example, the horizontal or vertical stability bars may include one or more receiving slots for receiving connecting pegs attached to sand wall planks, to allow sand wall planks to be attached according to the necessities of a given situation, such as existing sand depth, wind conditions, shore conditions, and other geographical considerations. In some embodiments, additional sand wall planks 111 may be added to create layers of planks. These additional planks may be at the same or different angles to the wind depending upon a desired shape of a dune. By using multiple layers, specific areas of diminished air speed may result, thus creating specifically tailorable patterns of sand.

In some embodiments, fences erected in accordance with the present invention may remain proximate to the created sand dune for short, medium, or long terms of engagement. In such embodiments, it may be desirable to suspend fence posts off of ground to allow turtles to pass underneath. A color-coded flag may be placed on vertical stability bar to indicate the relative height of the lowest panel. (For example, a red flag may indicate a relatively low opening between the fence and the sand, while a green flag may indicate a relatively high opening.). This may also be necessary to ensure compliance with local rules during, for example, turtle mating seasons.

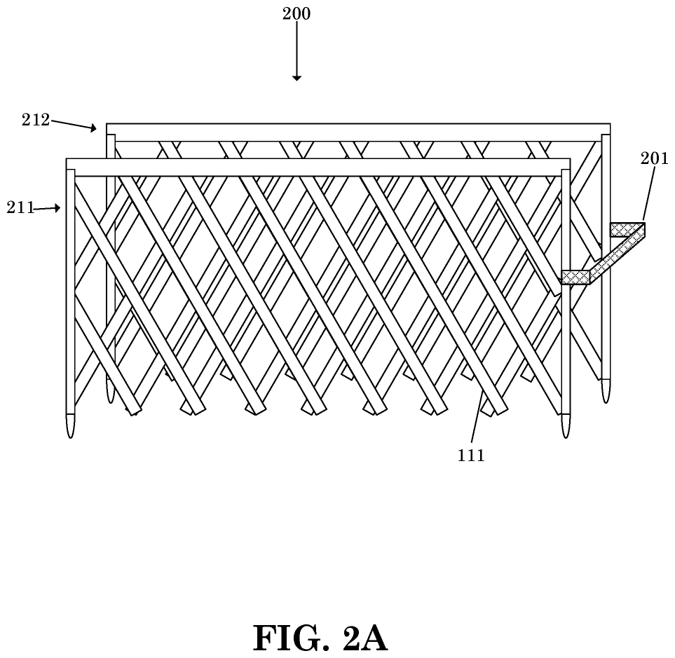

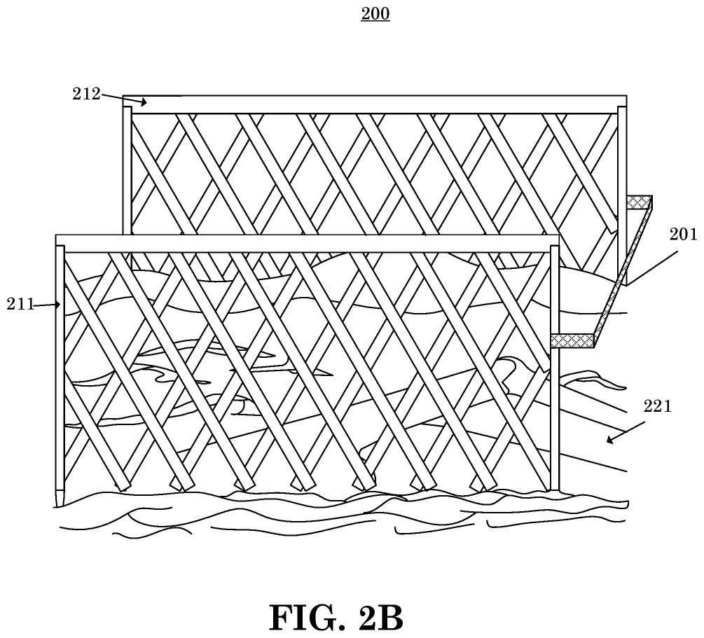

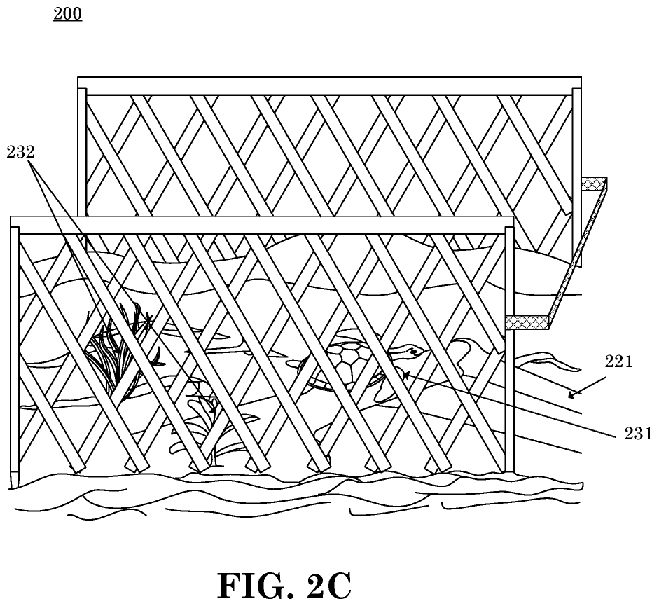

Referring now to FIG. 2, an exemplary embodiment of a paired sand dune apparatus 200 is shown. Paired sand dune apparatus 200 generally comprises one or more sand dune apparatus 211 or 212 (each similar to the sand dune apparatus 100 shown in FIG. 1) joined together with connecting apparatus 201. Connecting arm 201 may be a rotating arm, a pivoting arm, telescoping arm, or other means of adjusting alignment (i.e., the relative positions and orientations) of the one or more sand dune apparatus 211 or 212. Depending on the desired movement of the sand dune apparatus 211 or 212 relative to one another, one or more connecting apparatus may be used.

A benefit of the paired sand dune apparatus 200 is shown in FIGS. 2A-C. Being able to control the alignment of the constituent sand dune apparatus 100 is creating different sand passthrough profiles. For example, a front sand dune apparatus 211 may filter a certain relative quantity of sand by blocking some incoming sand with sand wall planks 111. In the embodiment of sand dune apparatus 100 shown in FIG. 1, the unblocked sand passes through the holes in the cross-hatch pattern to begin accumulating on the other side of sand dune apparatus 100.

In contrast, by placing a rear sand dune apparatus 212 at a short, downwind distance away from front sand dune apparatus 211, additional filtration of sand may occur. In the embodiment shown in FIG. 2A, approximately 50% of the sand that crosses through front sand dune apparatus 211 may be stopped from crossing through rear sand dune apparatus 212. In this way, a desired quantity of sand to accumulate on a sand dune (at a desired rate) can be more easily adjusted. This system may also add some redundancy in the overall system in case one of the sand dune apparatus 211 or 212 is blown down, destroyed, or otherwise rendered inoperable.

FIG. 2B illustrates an exemplary embodiment of paired sand dune apparatus 200 on sand dune 221. As can be seen in FIG. 2B, the collective cross-hatch patterning created by rear and frond sand dune apparatus 212 and 211 (respectively) creates a distinctive sand dune 211 in the area bounded by paired sand dune apparatus 200. FIG. 2C illustrates a benefit of this: these sand dune structures create shelter for sea turtles 231 and flora 232 that can safely grow between paired sand dune apparatus 200.

While FIGS. 2A-2C (and the remainder of the present disclosure generally) describe a paired sand dune apparatus (i.e., two sand dune apparatus connected by connecting arm 201), more than two sand apparatus may be deployed as necessary, with additional connecting arms. These additional connecting arms may be attached as necessary to achieve a desired sand dune shape. For example, an additional connecting arm could be attached to front sand dune apparatus 211 at the same point as the connecting arm 201, or it could be placed on the other side of front sand dune apparatus 211.

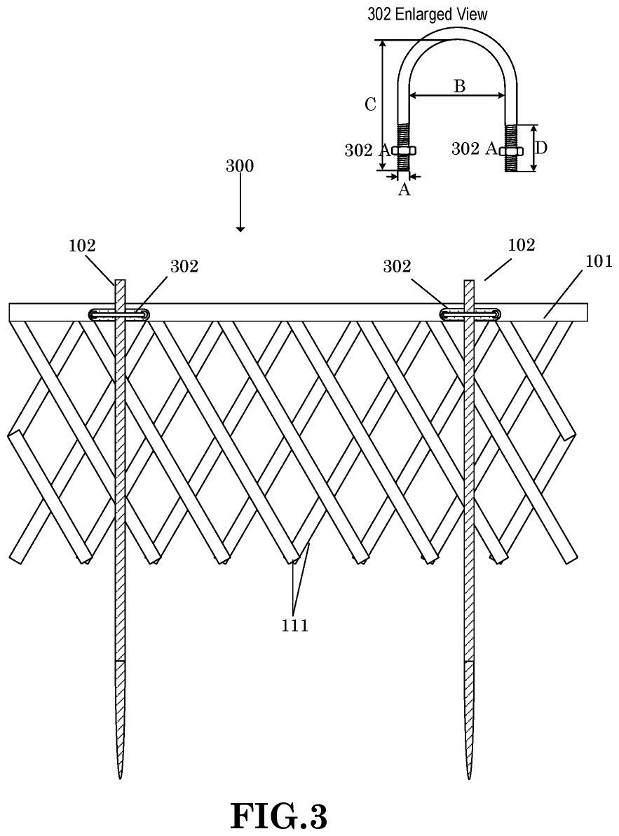

Referring now to FIG. 3, an alternative embodiment of the sand dune apparatus is shown. Stabilized sand dune apparatus 300 generally comprises lateral stability bar 101, vertical stability bars 102, and sand wall planks 111, as in the previous embodiments. Stabilized sand dune apparatus 300 further includes one or more stabilization loops 302 to use for attaching the vertical stability bars 102 to the lateral stability bar 101. Stabilization loop 302 may be located at any appropriate point along the lateral stability bar 101 to achieve stability or flexibility against environmental factors, such as wind. Stabilization loop 302 may also obviate the need to hold vertical stability bars 102 in rigid positions, which may be useful in some environments. In exemplary embodiments, two stabilization loops 302 are used and placed approximately symmetrically with respect to their distance from the center of lateral stability bar 101. (In some applications, it may be desirable to use a lateral stability bar 101 having a non-uniform density. In such applications, it may be desirable to position stabilization loops 302 symmetrically with respect to the center of mass of lateral stability bar 101, or it may be desirable to use vertical stability bars 102 having a non-uniform density.)

Stabilization loop 302 may principally comprise a U-bolt. A U-bolt is a bolt shaped like the letter U, having a threaded portion on both ends. An inside diameter and inside height of the U-bolt should be chosen to allow for the creation of a channel through which a vertical stability bar 102 may pass. Depending on the application, more or less room within the U for which the vertical stability bar 102 may move may be desirable. A first pair of nuts 302A may be threaded onto each end of the U-bolt, along with a bolt plate. Two or more nuts 302A allow the nuts to lock against each other and hold the U bolt 203 at a set distance from a surface of the stability bar and/or the dunes apparatus.

In the embodiment shown in FIG. 3, two holes (corresponding to the two ends of the U-bolt) may be drilled into lateral stability bar 101. The U-bolt may then be threaded through the holes, with the bend of the U extending perpendicularly from a front side of lateral stability bar 101. On the rear side of lateral stability bar 101, the U-bolt may be secured by threading a washer and one or more additional pairs of nuts to each end of the U. This may be useful to secure vertical stability bars 102 to lateral stability bar 101 without the need to cinch the nuts against the material of vertical stability bars 102.

In some applications, vertical stability bars 102 may be planted in the ground (comprising sand or other foundational material), and the remaining components of the stabilized sand dune apparatus 300 may be placed on top of vertical stability bars 102. This deployment may be simplified with the embodiment shown in FIG. 3, as it may be simpler for a user to loop stabilization loops 302 around already-planed vertical stability bars 102, rather than to position stabilized sand dune apparatus 300 and attempt to mount it to the ground by driving vertical stability bars 102 through stabilization loops 302 and into the ground.

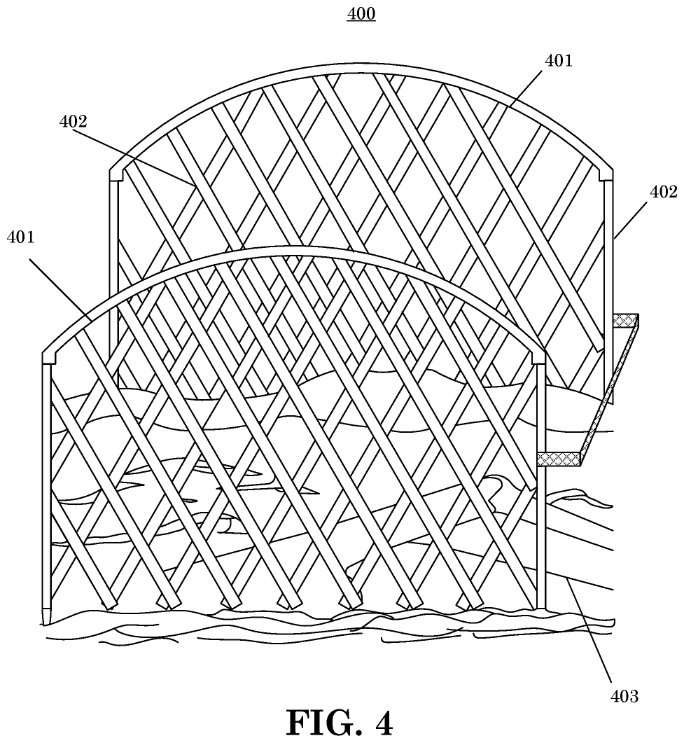

Referring now to FIG. 4, an alternate embodiment of a sand dune apparatus 400 is shown. Here, the lateral stability bar 401 is curved, rather than substantially straight, as in the embodiment shown in FIG. 1. Lateral stability bar 401 may still connect to vertical stability bars 402. Given the passage of time, winds bearing sand may create sand dune 403. In this embodiment, the use of curved lateral stability bar 401 may be more desirable than a substantially straight lateral stability bar in situations in which a particular sand dune structure is desired. For example, in areas of high wind speeds perpendicular to sand dune apparatus 400 (as measured by, for example, a windvane), sand may be blown over the top of curved lateral stability bar 401 to create a more hill-like structure than that created with a straight lateral stability bar.

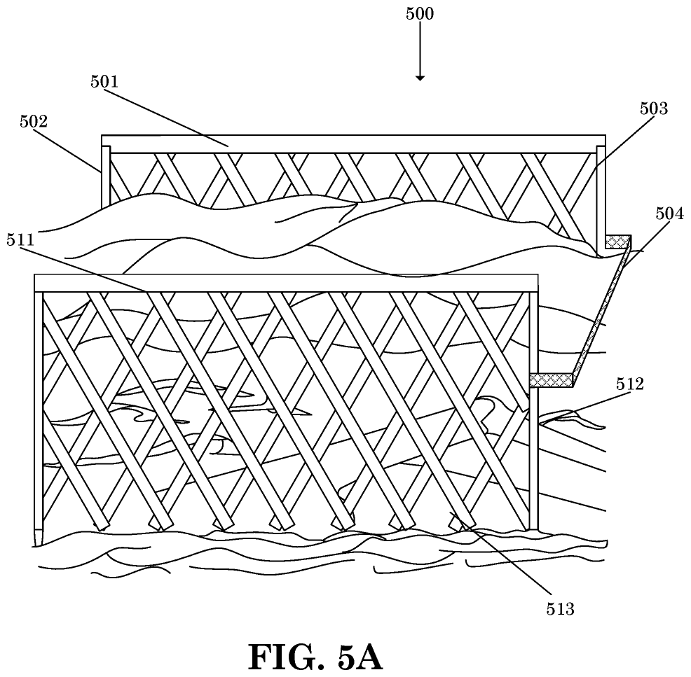

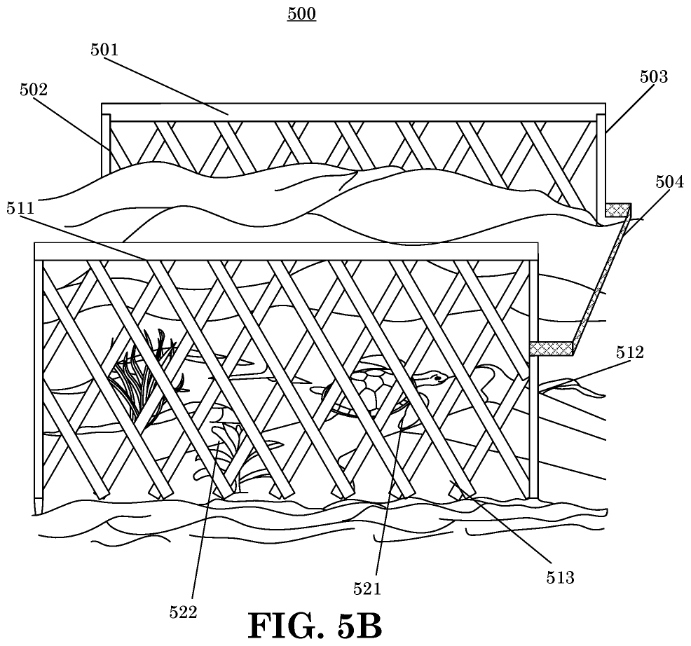

Referring now to FIGS. 5A-5B, it may be desirable to deploy sand dune apparatus 501 and 511 at different heights relative to each other to create differing height sand dune apparatus 500. As shown in FIG. 5A, rear sand dune apparatus 501 is shown with a smaller height than front sand dune apparatus 511 and connected thereto with connecting arm 504. The cross-hatched sand wall planks 503 513 of each respective sand dune apparatus may be the same shape as each other or different shapes. The varying height may be achieved by, for example, varying the heights of vertical stability bars 502 512. This may be achieved by using telescoping poles, extensions, or merely cutting the vertical stability bar 502 of the smaller, rear sand dune apparatus 501 to be of a smaller height than that of front sand dune apparatus 511.

As shown in FIG. 5B, a differing height sand dune apparatus may be desirable to create additional shelter for sea turtles 512 and flora 522. The smaller height of rear sand dune apparatus 501 may mean that additional sand comes into the area bounded by differing height sand dune apparatus 500, but its movement is inhibited beyond taller front sand dune apparatus 511. This may create a sheltered area depending upon the wind patterns and available sand volume in the relevant area. Additionally, differing height sand dune apparatus 500 may be desirable for creating an outcropping of dune with vegetation to offer additional protection to young sea turtles. Moreover, differing height sand dune apparatus 500 may be desirable for deployment to achieve propagation of a particular type of vegetation in a certain area based upon a necessary wind speed to propagate pollen, or to protect sensitive inland areas from the corrosive effects of windborne particles from the sea.

A fence post (i.e., a vertical stability bar) may be configured to support several panel heights for the fence. Moreover, these fences may be stacked to adjust for wind speed or a rate at which a sand dune should be built. For example, a higher fence will capture more sand particles. The fence may be stacked to adjust an amount of protection provided by fence panels from sea wind, which contain salt and sand.

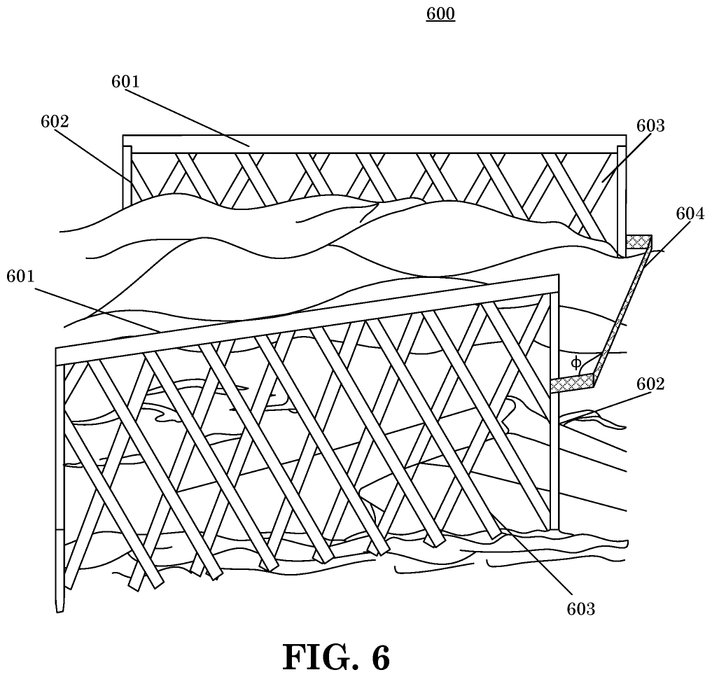

Referring now to FIG. 6, an alternative embodiment of a sand dune apparatus is shown. Here, angled sand dune apparatus 600 may create a different shape of a sand dune based upon the angle ϕ created by connecting arm 604. Angle ϕ may be perpendicular or 0-89.9 degrees. In the embodiment shown in FIG. 6, a standard version of sand dune apparatus 601 is shown, with vertical stability bar 602 and sand will planks 603, but any combination of differing height sand dune apparatus, curved sand dune apparatus, or the like may also be deployed with an angled connecting arm 604.

Angled sand dune apparatus 600 may be desirable for deployment in areas with unusual or uneven sand or wind patterns. It may also be desirable for deployment in areas with unique sheltering needs for flora and fauna. For example, on rockier costs, angled sand dune apparatus 600 may be deployed to create sheltered sand dune coves for local flora and fauna.

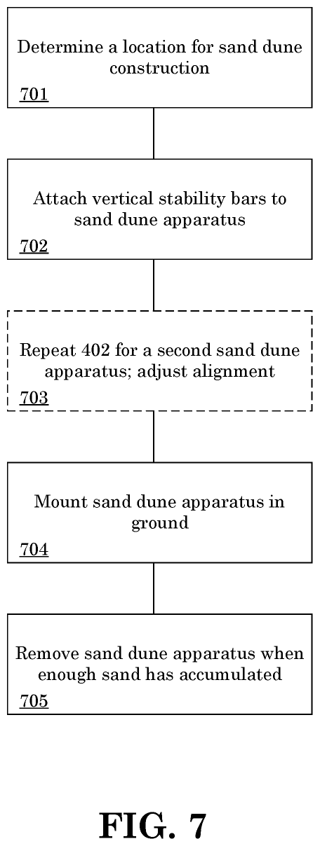

Referring now to FIG. 7, an exemplary method for passively building a sand dune is shown. At step 701, a location for sand dune construction is determined. The location may be based on one or more considerations, such as: privacy for beach homeowners, ecological regeneration, stabilization of geological features and prevention of erosion, designation of an inland area needing protection, desired construction sites, coastal repair, and similar considerations.

At this stage, the spacing and curvature of the bars and panels should be determined based upon a desired deployment. For example, greater spacing and curvature may be desirable where a purpose of the sand dune is to provide shelter for young sea turtles. Differing heights for the sand dune apparatus may be desirable to assist in the propagation of certain vegetation, or, additionally, to protect inland structures from the corrosive effects of particles borne by the wind from the sea.

The location may also take into consideration wind speed, direction, and other tendencies. These may be measured by, for example, placing a weathervane blade on top of a fence post in an area proximate to the location in which a dune is to be constructed. An anemometer may also be deployed where a wind intensity is desired to be obtained.

At step 702, vertical stability bars are attached to a lateral stability bar (having a plurality of sand wall planks attached thereto in a substantially cross-hatched pattern) to assemble a sand dune apparatus. In some embodiments, angles between the sand wall planks may be adjusted to create or modify a sand passthrough profile. A sand passthrough profile can determine a rate, quantity, or pattern of sand that can be blown by the wind (or other natural forces) through the sand wall apparatus. In some embodiments, one or more of the vertical stability bars may be attached to the lateral stability bar by passing the vertical stability bar through a stabilization loop, as described above. In some embodiments, the vertical stability bars may be placed at an appropriate distance apart at the location, and the rest of the sand dune apparatus may be attached thereto. In such embodiments, this attachment may be achieved by passing the vertical stability bars through stabilization loops (as shown in FIG. 3) or through another connecting means, as discussed in connection with FIGS. 1 and 2A-C.

In some embodiments, additional sand wall planks may be added to create layers of planks. These additional planks may be at the same or different angles to the wind depending upon a desired shape of a dune. By using multiple layers, specific areas of diminished air speed may result, thus creating specifically tailorable patterns of sand.

The size of openings in the fence may also be tailored to wind speed or to the distance sand particles should travel after passing through the fence. In addition, multiple layers of fence panels may have different sized openings to trap sand particles between the panels. Moreover, depending upon the location, the nearby sand may have larger or smaller sized or weighted particles. Accordingly, the relative weight of sand particles may be considered in choosing the placement of fence panels in relation to the area in which to create sand dunes.

The lateral stability bar, vertical stability bars, and sand wall planks may be made of material suitable for outdoor, humid deployment, such as wood or PVC. In addition, the sand wall planks can be made of more or less malleable material to dynamically adjust the rate, quantity, or pattern of sand that can be blown by the wind based upon the wind speed or other environmental factors. (For example, sand wall planks may be made of a stiff but flexible material, such as the vinyl or PVC draft curtains used to regulate airport luggage dispensing.)

In some embodiments, one or more secondary vertical stability bars may be attached to vertical stability bars (or on lateral stability bar or on one or more sand wall planks) extending downward at an angle from the vertical stability bar (and in a direction substantially perpendicular to the lateral stability bar) to bolster the stability of sand dune apparatus once it is mounted.

Optionally, at step 703, step 702 is repeated for a second sand dune apparatus. The first and second sand dune apparatus may be joined together with a connecting apparatus to allow for an adjustment of an alignment between the first and second sand dune apparatus.to modify the sand passthrough profile.

At step 704, the sand dune apparatus (or the first and second sand dune apparatus, if step 703 was completed) is mounted into the ground using the vertical stability bars at the location determined in step 701. The appropriate mounting depth for the vertical stability bars may be based on one or more of: type of ground (e.g., sand versus gravel), anticipated wind speed, anticipated sand transport speed, height of surrounding sand dunes (i.e., the vertical sand transport profile), etc. In some embodiments, the vertical stability bars may be secured in the ground by concrete, wet sand or an ecologically friendly, temporary mounting structure, or secondary stability bars. The secondary stability bars may be secured by attaching them to an anchoring apparatus buried in the ground near the location for sand dune construction, such as by bolting the secondary stability bars to a piece of plywood buried in the ground proximate to the location for sand dune construction.

Once mounted, the sand dune apparatus may serve to catch a certain proportion of sand blown in the direction of the sand apparatus. The sand may then fall on the ground proximate to the sand dune apparatus and begin accumulating. Over time, a sand dune will begin to form in a profile generally based upon the configuration of the sand dune apparatus.

In some embodiments, fences erected in accordance with the present invention may remain proximate to the created sand dune for short, medium, or long terms of engagement. In such embodiments, it may be desirable to suspend fence posts off of ground to allow turtles to pass underneath. A color-coded flag may be placed on a fence post to indicate the relative height of the lowest panel. (For example, a red flag may indicate a relatively low opening between the fence and the sand, while a green flag may indicate a relatively high opening.). This may also be necessary to ensure compliance with local rules during, for example, turtle mating seasons.

At step 705, once the sand dune has reached one or more desired goals, the sand dune apparatus may be removed. A desired goal may include, without limitation, a height of the sand dune, a planar expanse of a sand dune, a quality of sand in the sand dune, a concentration of a type of sand in the sand dune, ecological activity in the sand dune, a stabilization of geographical features proximate to the sand dune, or any other reason for which the location was chosen for sand dune construction. In some embodiments, the dune may be supplemented by plastic fiber or artificial sand particles, which may have a different weight and effect on local flora and fauna than natural sand.

After creating one sand dune, more sand dunes may be created in an area by repeating this method from step 701. This may be used, for example, to provide protection for turtles against natural predators. For instance, patterns of sand dunes may be used to protect cover from crows and seagulls (compared to the amount of cover that would be available on a beach). Similarly, sophisticatedly placed sand dunes could nurture various flora that could also provide cover from crows or seagulls.

Conclusion

Several embodiments of the present disclosure have been described. While this specification contains many specific implementation details, these should not be construed as limitations on the scope of any disclosures or of what may be claimed, but rather as descriptions of features specific to particular embodiments of the present disclosure. While embodiments of the present disclosure are described herein by way of example using several illustrative drawings, those skilled in the art will recognize the present disclosure is not limited to the embodiments or drawings described. It should be understood the drawings and the detailed description herein are not intended to limit the present disclosure to the form disclosed. Instead, the present disclosure is meant to encompass modifications, equivalents, and alternatives falling within the spirit and scope of embodiments of the present disclosure, as defined by the appended claims.

The headings used herein are for organization purposes only and are not meant to be used to limit the scope of the description or the claims. As used throughout this application, the word “may” is used in a permissive sense (i.e., meaning having the potential to), rather than the mandatory sense (i.e., meaning must). Similarly, the word “include” (and derivatives thereof) means including but not limited to. To facilitate understanding, like reference numerals have been used, where possible, to designate like elements common to the figures.

The phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

The term “a” or “an” entity means one or more of that entity. As such, “a”/“an,” “one or more,” and “at least one” are used interchangeably herein. Additionally, “comprising,” “including,” and “having” can be used interchangeably.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination an, in some cases, be excised from the combination, and the claimed combination may be directed to a sub-combination or a variation of a sub-combination.

What is claimed is:

1. A method for passive sand dune construction, the method comprising the steps of:
designating an areas on which sand will be aggregated to form a dune on a site;
designating a local wildlife type to protect with the dune, the selected wildlife comprising one or both of turtles and local flora;
determining a direction of wind at the site;
selecting a first dune forming panel comprising an area of multiple panel openings, at least some of the panel opening sizes based upon criteria comprising a speed of the wind, the size of sand particles to be included in the sand dune, and a distance of the area from the pane;
supporting a first dune forming panel with a first fence post at a location within a distance a sand particle may travel when the particle is transported by the wind;
arranging the first dune forming panel at an angle to the direction of the wind, wherein the angle to the direction of the wind is based upon a location of the area on which sand will be aggregated relative to first fence post supporting the fence panel;
propelling natural sand particles and plastic fiber particles through multiple panel openings with a force supplied by the wind; and
segregating natural sand particles and plastic fiber particles with a distance each is propelled by the wind; and
depositing at least one of the natural sand particles and plastic fiber particles in a location within the area.

2. The method of claim 1 additionally comprising the steps of:
a. attaching a first lateral stability bar to a first vertical stability bar with a first stabilization loop and a second vertical stability bar with a second stabilization loop;
b. extending the first vertical stability bar and the second vertical stability bar away from the first lateral stability bar; and
c. extending a first plurality of sand wall planks in a first direction from the first lateral stability bar and a second plurality of sand wall planks in a second direction from the first lateral stability bar, thereby forming the panel openings.

3. The method of claim 1, wherein the area is based upon the presence of a particular flora proximate to the area.

4. The method of claim 2, wherein the wind direction is monitored with a vane mounted on top of the first vertical stability bar.

5. The method of claim 1, wherein the wind direction is monitored with a flag mounted on top of the first vertical stability bar.

6. The method of claim 2, further comprising the steps of:
selecting a supplementary location for sand dune construction proximate to the location;
attaching second vertical stability bars to a second sand dune apparatus; and
mounting the second sand dune apparatus at the supplementary location. movably connecting the first and second sand dune apparatus with a connecting arm.

7. The method of claim 6, additionally comprising the step of movably attaching the first and dune apparatus to the second sand dune apparatus via a connecting arm fixedly fastening the first stability bar to the third vertical stability bar.

8. The method of claim 7, wherein the connecting arm is bendable in at least one direction and the method additionally comprises the step of bending the connecting arm to a length about equal to the distance between the first stability bar to the third vertical stability bar.

9. The method of claim 21, further comprising the step of supplementing the sand dune apparatus with artificial sand.

10. The method of claim 6, wherein the supplementary location is based upon a desired angle of sand accumulation based upon the location.

11. The method of claim 26, wherein the second vertical stability bars have a height smaller than the height of the first vertical stability bars.

12. The method of claim 1, further comprising the step of placing a windvane in a position proximate to the location to monitor wind direction, and wherein the step of selecting a location for sand dune construction is based upon a reading from the windvane.

13. The method of claim 1, further comprising the step of placing an anemometer in a position proximate to the location to monitor wind speed, and wherein the step of selecting a location for sand dune construction is based upon a reading from the anemometer.

14. The method of claim 1, wherein the first sand dune apparatus comprises a plurality of sand wall planks extending diagonally from a lateral stability bar.

15. The method of claim 11, additionally comprising the step of attaching a color code flag to one of the first and second sand dune apparatus, the color of the color code flag indicative of a height of a lowest panel of the one of the first and second sand dune apparatus to which the flag is attached, the height being sufficient to allow for turtles to pass beneath the lowest panel.

16. The method of claim 15 wherein the color code flag is attached during certain calendar dates during which baby turtles traverse the dunes.

17. The method of claim 11, additionally comprising creating a sand dune positioned to provide cover for baby turtles by interrupting a flight of gulls approaching a known path for the baby turtles.

18. The method of claim 11, additionally comprising creating a sand dune positioned to provide vegetation cover for baby turtles.

19. The method of claim 2 additionally comprising the step of stacking a second dune forming panel on top of the first dune forming panel to increase surface area of multiple panel openings.

20. The method of claim 19 wherein the stacking a second dune forming panel on top of the first dune forming panel to increases protection from wind bearing salt and sand.
